(19) United States
(12) Patent Application Publication
(10) Pub. No.: US 2024/0306102 A1
(43) Pub. Date: Sep. 12, 2024

(54) TRIGGER ASSISTED SYNCHRONIZATION FOR DEVICE-TO-DEVICE DISCOVERY

(71) Applicant: Samsung Electronics Co., Ltd., Suwon-si (KR)

(72) Inventors: Bilal Sadiq, Plano, TX (US); Boon Loong Ng, Plano, TX (US); Junsung Kim, Suwon-si (KR); Chi Ho Kim, Suwon-si (KR); Soonho Lee, Suwon-si (KR); Bu-Seop Jung, Suwon-si (KR)

(21) Appl. No.: 18/401,222

(22) Filed: Dec. 29, 2023

Related U.S. Application Data
(60) Provisional application No. 63/450,313, filed on Mar. 6, 2023.
(60) Provisional application No. 63/463,487, filed on May 2, 2023.

(51) Int. Cl. H04W 56/00; H04W 8/00

(52) U.S. Cl. CPC H04W 56/001; H04W 8/005

(57) ABSTRACT

A method includes receiving, at a first device via a first radio, a trigger from a second device, the first device configured for wireless communication using multiple radios sharing a clock, the multiple radios comprising the first radio and a second radio, the trigger including a timing indication. The method also includes determining, based on the timing indication in the trigger and a time of reception of the trigger, a timing of one or more operations of a radio of the second device for a discovery session between the first device and the second device. The method further includes starting the discovery session with the second device based on the determined timing of the one or more operations.

### CROSS-REFERENCE TO RELATED APPLICATIONS AND CLAIM OF PRIORITY

This application claims priority under 35 U.S.C. § 119(e) to U.S. Provisional Patent Application No. 63/450,313, filed on Mar. 6, 2023, and to U.S. Provisional Patent Application No. 63/463,487, filed on May 2, 2023, both of which are hereby incorporated by reference in their entirety.

### TECHNICAL FIELD

This disclosure relates generally to wireless communications systems. Embodiments of this disclosure relate to methods and apparatuses for trigger assisted synchronization for device-to-device (D2D) discovery.

### BACKGROUND

Device-to-device discovery or communication sessions between two or more devices are often triggered using a lower power consumption communication. Examples of device-to-device discovery or communication sessions are Neighborhood Aware Networking (NAN) and Wi-Fi direct, whereas examples of lower power consuming triggers are BLE advertisement, Zigbee, and Near Field Communication (NFC).

### SUMMARY

Embodiments of the present disclosure provide methods and apparatuses for trigger assisted synchronization for D2D discovery.

In one embodiment, a method includes receiving, at a first device via a first radio, a trigger from a second device, the first device configured for wireless communication using multiple radios sharing a clock, the multiple radios comprising the first radio and a second radio, the trigger including a timing indication. The method also includes determining, based on the timing indication in the trigger and a time of reception of the trigger, a timing of one or more operations of a radio of the second device for a discovery session between the first device and the second device. The method further includes starting the discovery session with the second device based on the determined timing of the one or more operations.

In another embodiment, a device includes multiple radios comprising a first radio and a second radio, the multiple radios sharing a clock. The device also includes a processor operably connected to the multiple radios. The processor is configured to: receive, via the first radio, a trigger from a second device, the trigger including a timing indication; determine, based on the timing indication in the trigger and a time of reception of the trigger, a timing of one or more operations of a radio of the second device for a discovery session between the device and the second device; and start the discovery session with the second device based on the determined timing of the one or more operations.

In another embodiment, a method includes sending, from a first device via a first radio, a trigger to a second device, the first device configured for wireless communication using multiple radios sharing a clock, the multiple radios comprising the first radio and a second radio. The method also includes starting a discovery session with the second device via the second radio. The trigger includes a timing indication, the timing indication based on (i) a planned timing of one or more operations of the second radio for the discovery session, and (ii) a transmission time of the trigger via the first radio.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of the present disclosure;

FIG. 3 illustrates an example system in which trigger assisted synchronization for D2D discovery can be performed according to various embodiments of the present disclosure;

FIG. 4 illustrates an example timeline illustrating use of the trigger assisted synchronization for D2D discovery in the system of FIG. 3 according to various embodiments of the present disclosure;

FIG. 5 illustrates an example chart showing differences between the loose synchronization-assisted discovery using the system of FIG. 3 versus a conventional discovery technique, according to various embodiments of the present disclosure;

FIG. 6 illustrates an example timeline showing the reporting accuracy of time of reception of a BLE trigger containing loose synchronization information, according to various embodiments of the present disclosure;

FIG. 7 illustrates an example timeline showing a process for updating the value of the countdown timer for each transmission of loose synchronization information, according to various embodiments of the present disclosure;

FIG. 8 illustrates a process for updating the value of the countdown timer for each transmission of loose synchronization information, according to various embodiments of the present disclosure;

FIG. 9 illustrates an example timeline showing the accuracy requirement of estimating the transmission time of a BLE trigger containing loose synchronization information, according to various embodiments of the present disclosure;

FIG. 10 illustrates an example table showing example data fields contained in a loose synchronization LTV, according to various embodiments of the present disclosure;

FIG. 11 illustrates a flow chart of a method for trigger assisted synchronization for D2D discovery at a receiver device according to various embodiments of the present disclosure; and

FIG. 12 illustrates a flow chart of a method for trigger assisted synchronization for D2D discovery at a sender device according to various embodiments of the present disclosure.

### DETAILED DESCRIPTION

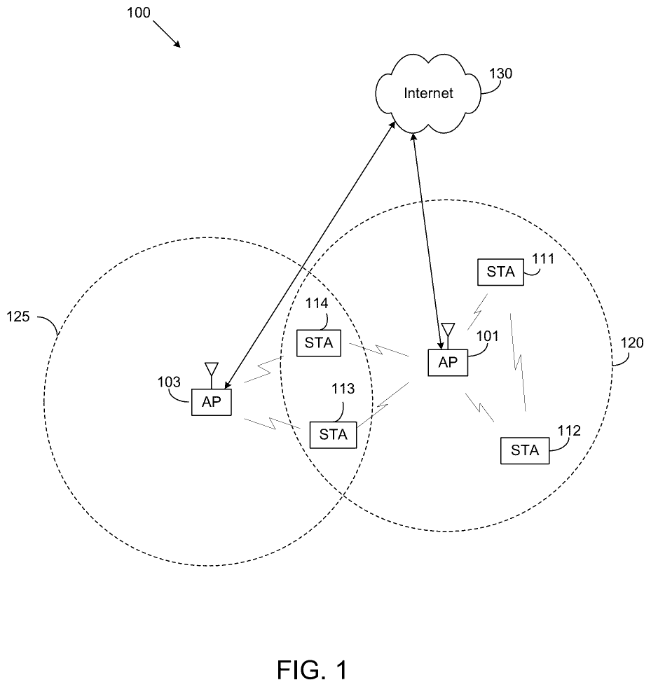

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

The present disclosure covers several components which can be used in conjunction or in combination with one another or can operate as standalone schemes. Certain embodiments of the disclosure may be derived by utilizing a combination of several of the embodiments listed below. Also, it should be noted that further embodiments may be derived by utilizing a particular subset of operational steps as disclosed in each of these embodiments. This disclosure should be understood to cover all such embodiments.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN (wireless local area network) communication techniques. The STAs 111-114 may communicate with each other using peer-to-peer protocols, such as Tunneled Direct Link Setup (TDLS).

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming to enable trigger assisted synchronization for D2D discovery. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provide STAs with direct wireless broadband access to the network 130. Further, the APs 101 and/or 103 could provide access to other or additional external networks, such as external telephone networks or other types of data networks.

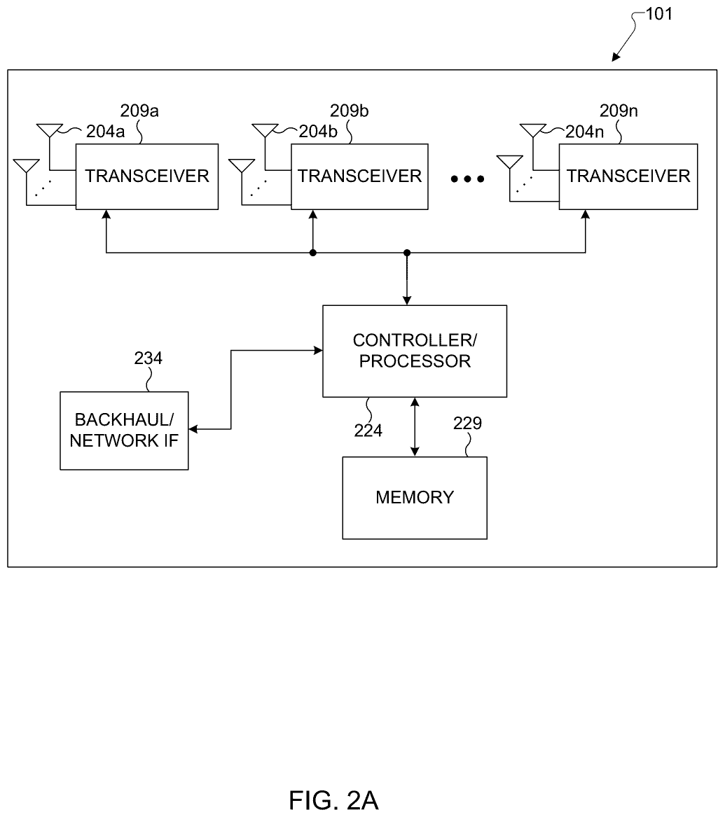

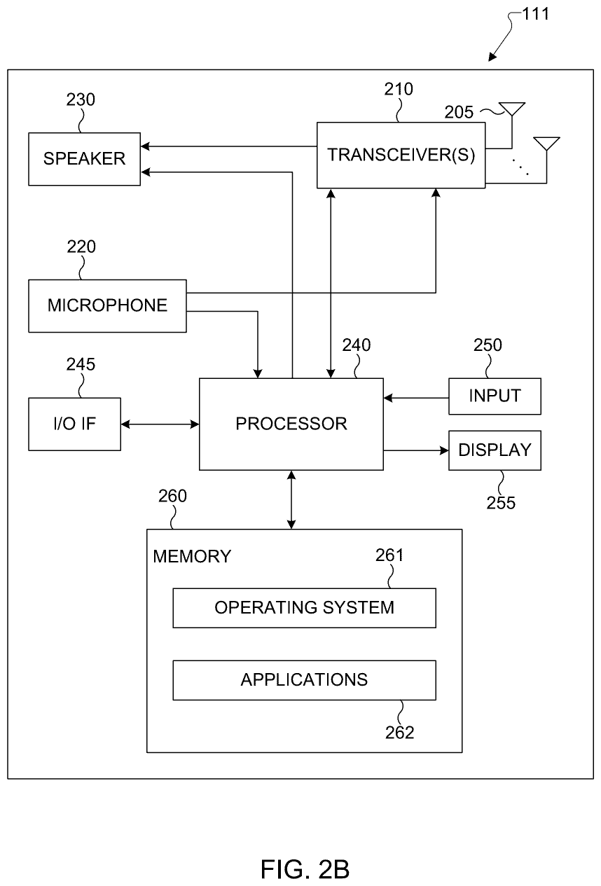

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

The AP 101 includes multiple antennas 204a-204n and multiple transceivers 209a-209n. The AP 101 also includes a controller/processor 224, a memory 229, and a backhaul or network interface 234. The transceivers 209a-209n receive, from the antennas 204a-204n, incoming radio frequency (RF) signals, such as signals transmitted by STAs 111-114 in the network 100. The transceivers 209a-209n down-convert the incoming RF signals to generate IF or baseband signals. The IF or baseband signals are processed by receive (RX) processing circuitry in the transceivers 209a-209n and/or controller/processor 224, which generates processed baseband signals by filtering, decoding, and/or digitizing the baseband or IF signals. The controller/processor 224 may further process the baseband signals.

Transmit (TX) processing circuitry in the transceivers 209a-209n and/or controller/processor 224 receives analog or digital data (such as voice data, web data, e-mail, or interactive video game data) from the controller/processor 224. The TX processing circuitry encodes, multiplexes, and/or digitizes the outgoing baseband data to generate processed baseband or IF signals. The transceivers 209a-209n up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the transceivers 209a-209n in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including enabling trigger assisted synchronization for D2D discovery. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for trigger assisted synchronization for D2D discovery. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. Alternatively, only one antenna and transceiver path may be included, such as in legacy APs. Also, various components in FIG. 2A could be combined, further subdivided, or omitted and additional components could be added according to particular needs.

FIG. 2B illustrates an example STA 111 according to various embodiments of the present disclosure. The embodiment of the STA 111 illustrated in FIG. 2B is for illustration only, and the STAs 112-114 of FIG. 1 could have the same or similar configuration. However, STAs come in a wide variety of configurations, and FIG. 2B does not limit the scope of this disclosure to any particular implementation of a STA.

The STA 111 includes antenna(s) 205, transceiver(s) 210, a microphone 220, a speaker 230, a processor 240, an input/output (I/O) interface (IF) 245, an input 250, a display 255, and a memory 260. The memory 260 includes an operating system (OS) 261 and one or more applications 262.

The transceiver(s) 210 receives from the antenna(s) 205, an incoming RF signal (e.g., transmitted by an AP 101 of the network 100). The transceiver(s) 210 down-converts the incoming RF signal to generate an intermediate frequency (IF) or baseband signal. The IF or baseband signal is processed by RX processing circuitry in the transceiver(s) 210 and/or processor 240, which generates a processed baseband signal by filtering, decoding, and/or digitizing the baseband or IF signal. The RX processing circuitry sends the processed baseband signal to the speaker 230 (such as for voice data) or is processed by the processor 240 (such as for web browsing data).

TX processing circuitry in the transceiver(s) 210 and/or processor 240 receives analog or digital voice data from the microphone 220 or other outgoing baseband data (such as web data, e-mail, or interactive video game data) from the processor 240. The TX processing circuitry encodes, multiplexes, and/or digitizes the outgoing baseband data to generate a processed baseband or IF signal. The transceiver(s) 210 up-converts the baseband or IF signal to an RF signal that is transmitted via the antenna(s) 205.

The processor 240 can include one or more processors and execute the basic OS program 261 stored in the memory 260 in order to control the overall operation of the STA 111. In one such operation, the processor 240 controls the reception of forward channel signals and the transmission of reverse channel signals by the transceiver(s) 210 in accordance with well-known principles. The processor 240 can also include processing circuitry configured to enable trigger assisted synchronization for D2D discovery. In some embodiments, the processor 240 includes at least one microprocessor or microcontroller.

The processor 240 is also capable of executing other processes and programs resident in the memory 260, such as operations for enabling trigger assisted synchronization for D2D discovery. The processor 240 can move data into or out of the memory 260 as required by an executing process. In some embodiments, the processor 240 is configured to execute a plurality of applications 262, such as applications to enable trigger assisted synchronization for D2D discovery. The processor 240 can operate the plurality of applications 262 based on the OS program 261 or in response to a signal received from an AP. The processor 240 is also coupled to the I/O interface 245, which provides STA 111 with the ability to connect to other devices such as laptop computers and handheld computers. The I/O interface 245 is the communication path between these accessories and the processor 240.

The processor 240 is also coupled to the input 250, which includes for example, a touchscreen, keypad, etc., and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As discussed above, D2D discovery or communication sessions between two or more devices are often triggered using a lower power consumption communication. Examples of D2D discovery or communication sessions are Neighborhood Aware Networking (NAN) and Wi-Fi direct, whereas examples of lower power consuming triggers are BLE advertisement, Zigbee, and Near Field Communication (NFC).

In addition to merely triggering a session, these triggers may also be used to create a loose timing synchronization between the devices (e.g., sub-1 ms to 20 ms accuracy). This loose synchronization may then be exploited to improve the session setup experience in terms of latency, power consumption, reliability, and interruption to other ongoing communication operations such as Wi-Fi. For example, the loose synchronization can be used to align the scan time and channel on the receiving device with the transmission time and channel of the transmitting device. However, most conventional devices are not capable of using triggers to create a loose synchronization between (or among) devices.

To address these and other issues, this disclosure provides systems and methods for trigger assisted synchronization for D2D discovery. As described in more detail below, the disclosed embodiments exploit D2D discovery triggers to create a timing synchronization between the devices, and to use the timing synchronization to improve the session set-up performance. The disclosed embodiments provide multiple advantageous benefits over conventional systems that perform D2D discovery. For example, the disclosed embodiments enable a reduction in total interruption time due to NAN Subscribe operation. Also, the disclosed embodiments enable a reduction in discovery latency.

Note that while some of the embodiments discussed below are described in the context of smart phones, these are merely examples. It will be understood that the principles of this disclosure may be implemented in any number of other suitable contexts or systems, including other portable electronic devices (e.g., tablets, laptops, and the like).

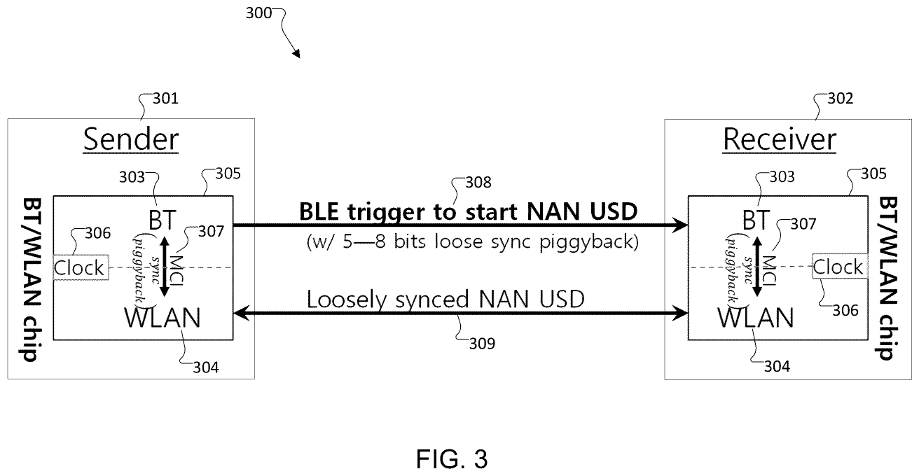

FIG. 3 illustrates an example system 300 in which trigger assisted synchronization for D2D discovery can be performed according to various embodiments of the present disclosure. As shown in FIG. 3, a sender device 301 and a receiver device 302 are configured to engage in a device discovery session, such as a device-to-device (D2D) discovery session or a discovery of services offered by (or executing on) devices. Each of the devices 301 and 302 has multiple radios, including a first radio 303 and a second radio 304. In some embodiments, the first radio 303 is a low-power, always-on radio such as Bluetooth, and the second radio 304 is a WLAN radio. Of course, these are merely examples, and other combinations of radios are possible and within the scope of this disclosure. For example, other possible combinations of radios include WUR and WLAN or NFC and WLAN. The radios 303 and 304 of each device 301 and 302 are disposed together on a common chip 305 (e.g., a BT/WLAN chip) and share a common on-chip hardware system clock 306. In addition, an on-chip communication interface 307 between the two radios 303 and 304 (e.g., a BT/WLAN multi-radio coexistence interface (MCI)) allows for upper layer communication between the two radios 303 and 304.

As described in greater detail below, the first radio 303 of each device 301 and 302 can be used to send or receive a trigger 308 for starting operation of the second radio 304 (e.g., Wi-Fi operation). That is, the first radio 303 of the sender device 301 sends the trigger 308, and the first radio 303 of the receiver device 302 receives the trigger 308. In some embodiments, the trigger 308 is a Bluetooth low energy (BLE) trigger or advertisement that is used to start a discovery session 309, such as a NAN unsynchronized service discovery (USD) session, between the devices 301 and 302.

In conventional discovery techniques, a first device (e.g., a USD Publisher device) may send a BLE trigger (which is later retransmitted a few times). Then, after some delay, the first device starts a USD Publish instance in the Single Channel Publish (SCP) state. In SCP, the first device transmits a Publish SDF periodically (e.g., every 60˜80 ms) on the designated default publish channel (e.g., CH6 (social channel)). Then, the first device enters the non-SCP (NSCP) state (e.g., goes back to an AP channel to maintain an AP connection). As known in the art, during SCP, the Publisher operates (e.g., transmits publish messages and listens for Subscribe or Follow-up messages from a potential Subscriber) on the default publish channel only. Whereas during NSCP, the Publisher operates over a channel from a list (e.g., the list of all channels excluding the default publish channel) and iterates over all the channels in the list. The NSCP state can also be referred to a Multiple Channel Publish (MCP) state.

The second device (e.g., a Subscriber device) receives the trigger and starts a USD Subscribe session with the Publisher device and scans the default publish channel with a duty cycle based on any other concurrent operation. Typically, the Subscriber device may not be able to predict whether the Publisher is in the SCP state or the NSCP state, and thus follows a randomized channel scan behavior.

In contrast, in the system 300 of FIG. 3, the sender device 301 can include additional loose synchronization piggyback information in the BLE trigger 308. In some embodiments, the information can include 5-8 bits of information in a LTV (Length-Type-Value) structure. For example, the LTV may contain 1 bit that indicates the current USD Publisher state (i.e., SCP or NSCP) of the sender device 301, and a 4-7 bit timing indication, which may be formatted as a countdown timer indicating the remaining duration in the current Publisher state (e.g., in multiples of 10 ms). In some embodiments, the timing indication is based on (i) the planned timing of one or more steps of the operation of the second radio 304, and (ii) the time of transmission of the BLE trigger 308. The discovery session 309 can then be synchronized between the devices 301 and 302 using the time of transmission or reception of the BLE trigger 308, and the synchronization piggyback information included in the BLE trigger 308. For example, the receiver device 302 can determine the timing of one or more steps of the operation of its second radio 304 based on (i) the timing indication in the trigger 308, and (ii) the time of reception of the trigger 308. As described in greater detail below, this enables faster discovery, significantly less interruption to concurrent operation, and power savings in the receiver device 302.

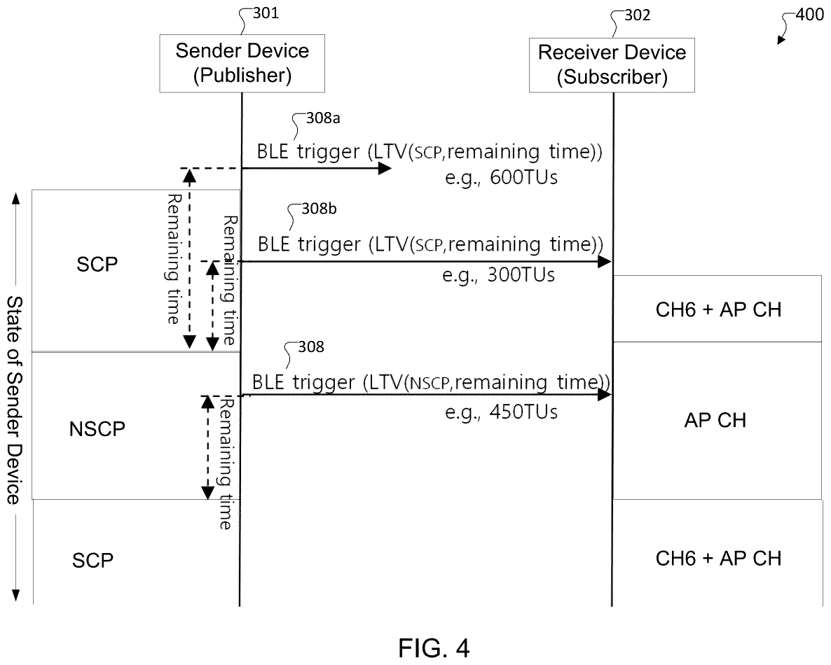

FIG. 4 illustrates an example timeline 400 illustrating use of the trigger assisted synchronization for D2D discovery in the system 300 according to various embodiments of the present disclosure. As shown in FIG. 4, the first BLE trigger 308 (indicated as 308a) is sent before the start of the NAN Publish session, and indicates the current state (i.e., either SCP or NSCP) of the sender device 301. The first BLE trigger 308a also contains the loose synchronization LTV with the countdown timer indicating the remaining time (e.g., 600 ms) of the sender device 301 in the current state, i.e., the time until the next SCP-to-NSCP transition. In some embodiments, the current state may be indicated as either SCP or NSCP, e.g., depending on the remaining time until the start of NAN Publish. For example, if the time to start NAN Publish is less than a threshold (such as 100 ms), then the indicated state may be SCP, and the countdown timer may indicate the time remaining until the next SCP-to-NSCP transition. Otherwise (i.e., if the time to start NAN Publish is greater than the threshold), then the indicated state may be NSCP, and the countdown timer may indicate the time remaining until the start of NAN Publish.

Each BLE trigger 308 is usually transmitted on all three advertisement channels (CH37-CH39) successively over a short window, e.g., 10 ms. In FIG. 4, each BLE trigger arrow represents advertisement transmissions on all three advertisement channels, which may all contain the identical LTV. That is, the remaining time field of the LTV may not be updated for the three transmissions on BLE advertisement channels. However, the LTV in the second BLE trigger 308b contains the updated countdown timer indicating the new smaller remaining time (e.g., 300 ms) until the SCP-to-NSCP transition.

The receiver device 302 can receive one or more of the BLE triggers 308 from the sender device 301. Upon receiving a BLE trigger 308 configured with the loose synchronization LTV, the receiver device 302 can now predict the current state of the sender device 301 and the time of the next SCP/NSCP transition to an accuracy of, e.g., +/−5 ms. By decoding the loose synchronization LTV information, the receiver device 302 may maintain multiple indicators, including a Predicted_Current_Publisher State and Time_of Next State Transition.

When the Predicted_Current_Publisher_State is NSCP, then until the next NSCP-to-SCP transition, the receiver device 302 may not waste time scanning the default publish channel (e.g., CH6). Instead, the receiver device 302 may stay on the AP channel (i.e., the channel on which it is connected to a Wi-Fi Access Point), the channel of any other ongoing activity, or a randomly selected channel other than the default publish channel. On this channel, the receiver device 302 may continue to scan for publish messages opportunistically (e.g., as often as possible based on other ongoing activity), since the sender device 301 in NSCP may randomly publish on this channel.

When the Predicted_Current_Publisher_State is SCP, then until the next SCP-to-NSCP transition, the receiver device 302 may scan the default publish channel as much as possible. For example, if the receiver device 302 is connected to an AP on a different channel than the default publish channel, the receiver device 302 may scan the default publish channel for Publish messages with 50% duty cycle. Or if the receiver device 302 has no other ongoing operation, the receiver device 302 may scan the default publish channel with 100% duty cycle. Therefore, the receiver device 302 may adjust the duty cycle based on the Predicted_Current_Publisher_State. Moreover, the receiver device 302 may (attempt to) start scanning the default publish channel coinciding with the NSCP-to-SCP transition (or at the start of the Subscribe instance if the instance starts with Predicted_Current_Publisher_State=SCP).

Thus, the receiver device 302 exploits the loose synchronization for faster discovery and power savings. For example, during predicted SCP state, the receiver device 302 may maximize scan time on the default publish channel, whereas during predicted NSCP state, the receiver device 302 may avoid wasting time on the default publish channel and instead opportunistically determine the scan channel based on other ongoing operations. Note that avoiding the default publish channel during predicted NSCP can provide multiple benefits—(1) less interruption to other ongoing operations, and (2) a higher probability of USD success during NSCP (e.g., due to not wasting time scanning the default publish channel during NSCP and instead spending that time scanning a channel that the sender device 301 may indeed transmit on during NSCP).

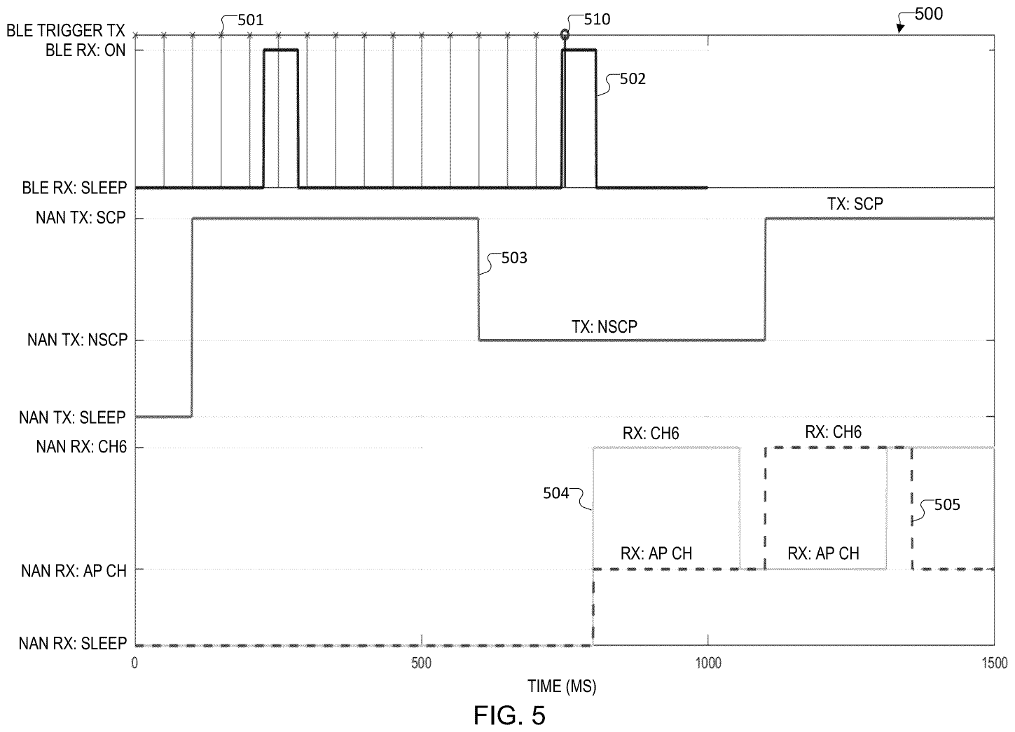

FIG. 5 illustrates an example chart 500 showing differences between the loose synchronization-assisted discovery using the system 300 versus a conventional discovery technique, according to various embodiments of the present disclosure. As shown in FIG. 5, the chart 500 includes multiple plots 501-505 representing behavior of the sender device 301 and the receiver device 302. In particular, the plot 501 indicates BLE trigger transmission by the sender device 301, the plot 502 indicates the BLE receiver duty cycle of the receiver device 302, the plot 503 indicates the NAN transmission state of the sender device 301, the plot 504 indicates the NAN reception behavior of the receiver device 302 using a conventional discovery technique, and the plot 505 indicates the NAN reception behavior of the receiver device 302 using the loose synchronization-assisted discovery techniques of the system 300.

As indicated by the plot 501, the sender device 301 (the publisher) repeatedly transmits the BLE trigger 308. The receiver device 302 (the subscriber) fails to receive most of the BLE triggers 308; however, the receiver device 302 successfully receives a BLE trigger 308 at around 750 ms (as indicated at 510). At that time, the sender device 301 is in NSCP state with another approximately 350 ms remaining in NSCP, as indicated by the plot 503. Using conventional techniques, the receiver device 302 may start scanning the default publish channel (CH6) with 50% duty cycle as soon as the BLE trigger 308 is received, as indicated by the plot 504. In contrast, the receiver device 302—by knowing the current Publisher state of the sender device 301 and the remaining time through the loose synchronization information obtained from the BLE trigger 308—remains on the AP channel until the next NSCP-to-SCP transition of the sender device 301 (at approximately 1100 ms), and starts scanning CH6 (the default publish channel) as soon as SCP starts, as indicated by the plot 505. It is noted that channel (or state) switching delays are ignored for this illustration.

In the NSCP state, the publisher may perform other ongoing operations such as communicating with an AP on an AP channel, and may not transmit any USD-related publish messages. In such a more general case, the loose synchronization information may indicate a remaining duration until the next SCP-to-NSCP transition or NSCP-to-SCP transition; this is illustrated in FIG. 4. Moreover, even though the Publisher device has been described as iterating between two states, more generally, it may iterate between more than two states. In some embodiments, the loose synchronization information may include an indication of time, where the time may correspond to the remaining time in a device state, the time until a state transition, or time spent in the current state.

As discussed above, the radios 303 and 304 of the sender device 301 and the receiver device 302 share a common clock 306. This may be a clock in the physical (PHY) layer or a system clock. The clock 306 maintains a timing reference t that is used to determine the new value of the countdown timer in the LTV of each retransmission. It will be assumed herein that the time t is in units of 1 ms. At the receiver device 302, the clock 306 can also be used to report the time of reception of a BLE trigger 308. Accuracy and resolution requirements of timing events such as TX time and RX time according to the clock time t are discussed next.

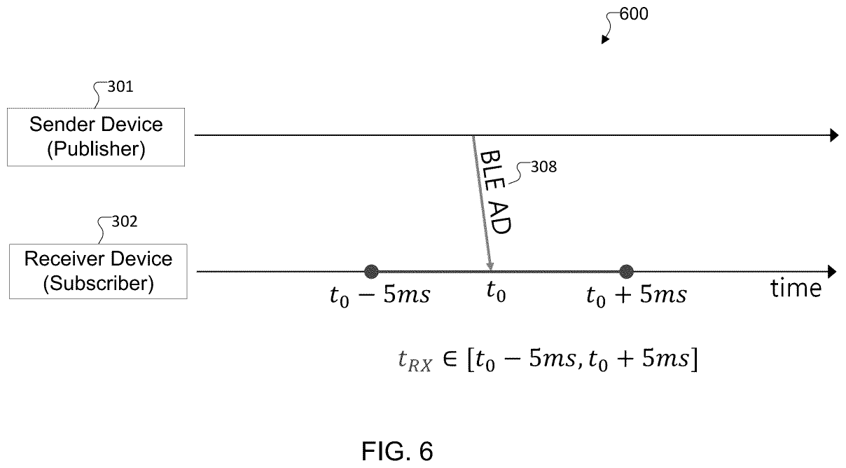

FIG. 6 illustrates an example timeline 600 showing the reporting accuracy of time of reception of a BLE trigger containing loose synchronization information, according to various embodiments of the present disclosure. As shown in FIG. 6, the sender device 301 transmits a BLE trigger 308 (e.g., a BLE advertisement message) containing loose synchronization information. When the receiver device 302 (in particular, the BLE module of the receiver device 302) successfully decodes the BLE trigger 308, it may report a time of reception t_{RX} of the BLE trigger 308 to, e.g., a service layer, a D2D session setup manager, or a D2D session synchronization manager. The reported time t_{RX} may be accurate to a preconfigured limit such as +/−5 ms (although in some embodiments, a lower accuracy of +/−10 ms or +/−15 ms may be acceptable). For example, if the actual time of reception is to (as shown in FIG. 6), then the reported time of reception may be required to satisfy t_{RX}∈[t₀−5 ms, t₀+5 ms]. Moreover, the receiver device 302 may report one or more contents of the received loose synchronization information, such as the countdown timer and the current state information.

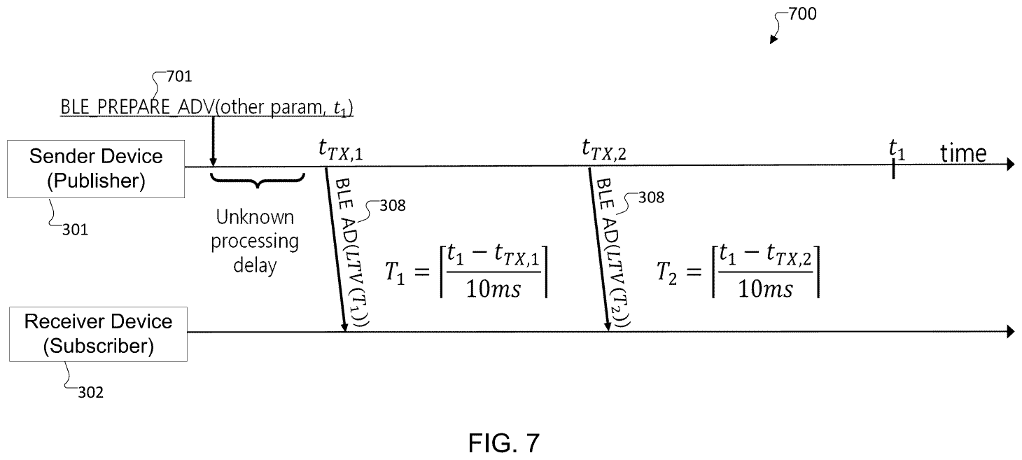

FIG. 7 illustrates an example timeline 700 showing a process for updating the value of the countdown timer for each transmission of loose synchronization information, according to various embodiments of the present disclosure. As shown in FIG. 7, once the service layer requests the sender device 301 (in particular, the BLE module) to send a BLE trigger 308 (e.g., a BLE advertisement message), the actual time of transmission at the PHY layer may depend on many factors including device configuration, current power state, and other ongoing activity. Since the value of the countdown timer in the loose synchronization information (e.g., LTV) depends on the actual time of transmission, the transmission procedure and APIs may be designed in such a way that they are agnostic to the processing delay of lower layers. Such a procedure and APIs are described below.

The command 701 to transmit the BLE trigger 308 (e.g., a BLE_PREPARE_ADV command) may not directly include a value of countdown timer T to be included in the loose synchronization LTV. Instead, the command 701 may include a future time t₁. This future time parameter provided in the command 701 may be referred to as a timing anchor and may be according to the local clock. For example, t₁ may be the time of the next SCP/NSCP transition. For example, suppose t₁=1,600 ms while the current time according to the local clock (i.e., the time the command is given) is 1,000 ms.

The sender device 301 (e.g., the BLE module) may then determine the expected time of first transmission t_{TX,1} of the BLE trigger 308 based on other ongoing activity and the state of the sender device 301. For example, the BLE module can estimate t_{TX,1}=1,120 ms, which is a processing delay of 120 ms between the command and the actual transmission from the PHY layer of the BLE module. Then, the BLE module can derive the value of the countdown timer for the first transmission of the Loose Synchronization LTV based on the provided timing anchor (t₁) and the estimated actual transmission time (t_{TX,1}), e.g., as

$${T}_{1} = ⌈ \frac{{t}_{1} - {t}_{TX , 1}}{10 ms} ⌉ ,$$

and generate the LTV with this value. E.g.,

$${T}_{1} = ⌈ \frac{{t}_{1} - {t}_{TX , 1}}{10 ms} ⌉ = 48 units$$

for t₁=1,600 ms and t_{TX,1}=1,120 ms as above. In some embodiments, the same value of the countdown timer may be used for all three transmissions on BLE channels 37-39, or a separate value of the countdown timer may be derived based on the estimated actual transmission time per BLE channel.

For the next transmission, the BLE module may follow the same procedure: it may determine the expected time of the next transmission t_{TX,2}, and use that (alongside the provided timing anchor t₁) to derive the updated value of the countdown timer for this transmission, e.g., as

$${T}_{2} = ⌈ \frac{{t}_{1} - {t}_{TX , 2}}{10 ms} ⌉ .$$

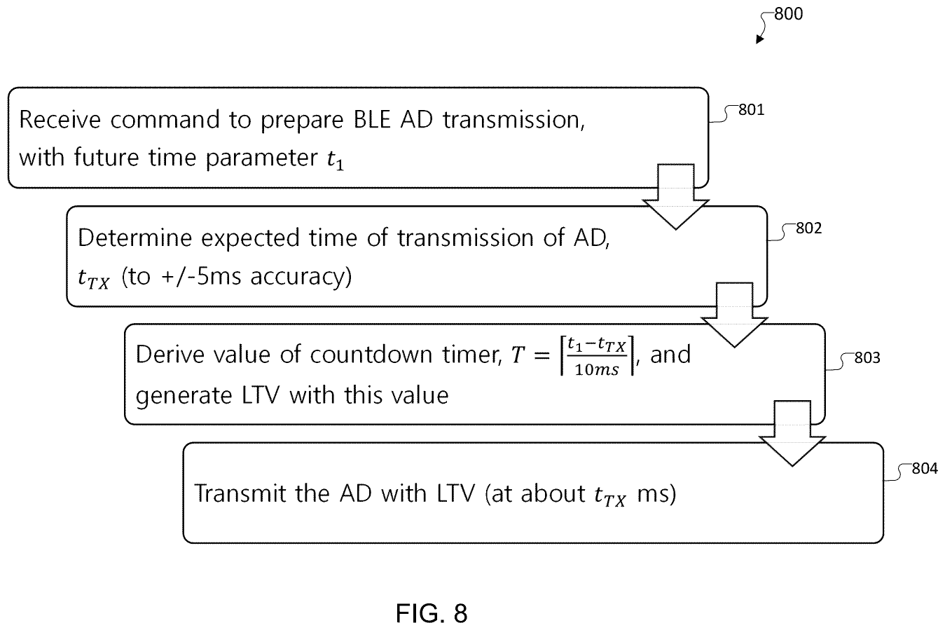

FIG. 8 illustrates a process 800 for updating the value of the countdown timer for each transmission of loose synchronization information, according to various embodiments of the present disclosure. The process 800 is based on the process described above in conjunction with FIG. 7. As shown in FIG. 8, at operation 801, the sender device 301 receives a command to prepare a transmission of a BLE trigger 308, with a future time parameter t₁. At operation 802, the sender device 301 determines an expected transmission time t_{TX} of the BLE trigger 308. At operation 803, the sender device 301 derives the value of the countdown timer

$$T = ⌈ \frac{{t}_{1} - {t}_{TX}}{10 ms} ⌉$$

and generates the LTV with this value. At operation 804, the sender device 301 transmits the BLE trigger 308 with the LTV.

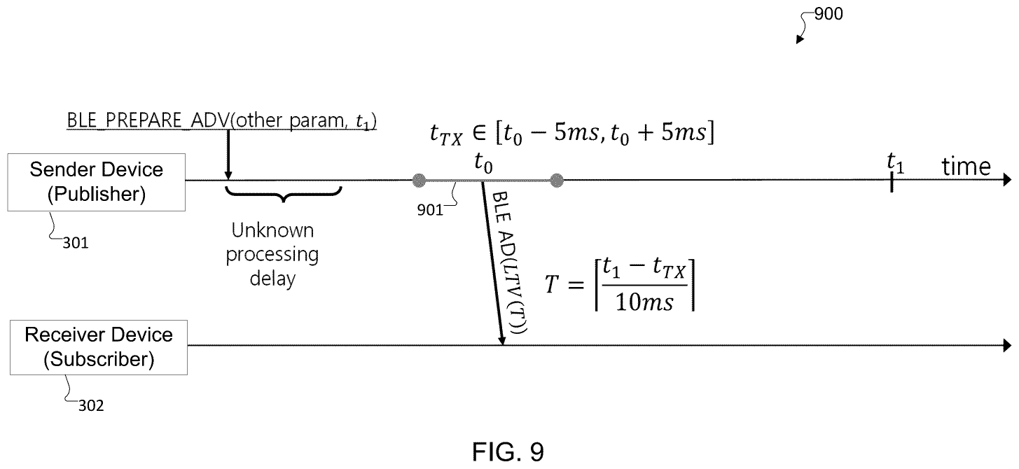

In some embodiments, accuracy of the estimated transmission time t_{TX} may be within a preconfigured range, e.g., +/−5 ms. FIG. 9 illustrates an example timeline 900 showing the accuracy requirement of estimating the transmission time of a BLE trigger containing loose synchronization information, according to various embodiments of the present disclosure. As shown in FIG. 9, if the actual transmission time is to, the the estimated transmission time may be required to satisfy t_{TX}∈[t₀−5 ms, t₀+5 ms], as indicated by the range 901.

More generally, the command to transmit loose synchronization information in a trigger (e.g., a BLE advertisement with Loose Synchronization LTV) may include multiple future timing anchors (t₁, t₂, . . . , t_{N}) where t₁<t₂< . . . <t_{N}. While the current time t<t₁, the BLE module may use the first timing anchor t₁ to derive the value of the countdown timer. After the “expiration” of the first timing anchor (i.e., after the current time t≥t₁ but t<t₂), the BLE module may use the second timing anchor t₂ to derive the value of the countdown timer. This process can repeat until the last timing anchor ty is reached. The trigger-sending device (e.g., the sender device 301) will stop sending the loose synchronization LTV after time t_{N}.

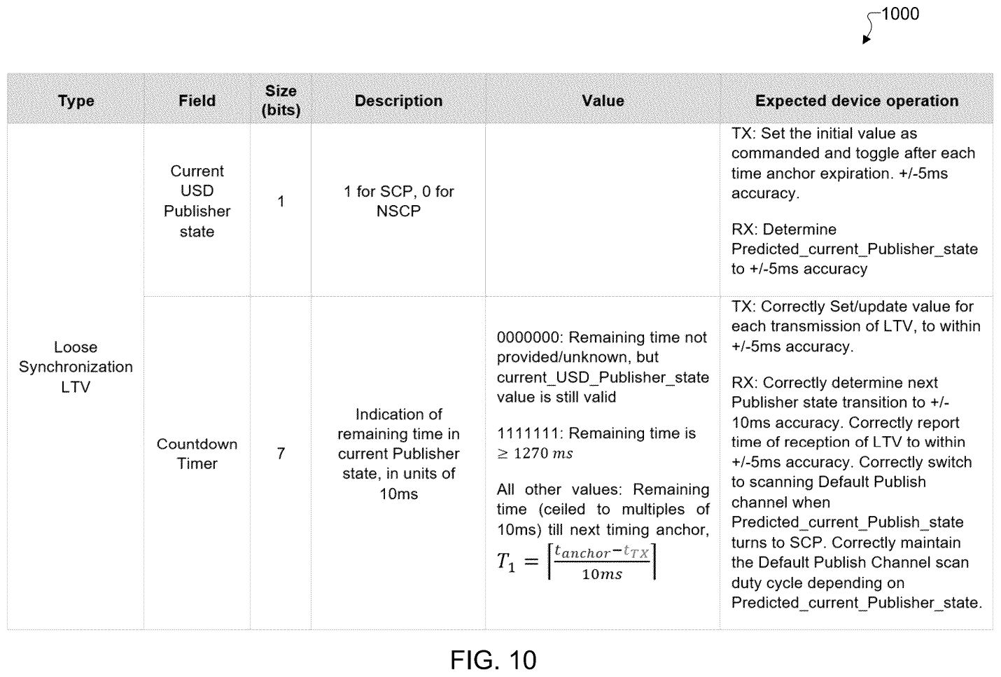

In addition to future timing anchors (t₁, t₂, . . . , t_{N}), the command to transmit a BLE advertisement with loose synchronization LTV may include the Current_Publisher State (‘SCP’ or ‘NSCP’) bit. The BLE module may toggle the Current_Publisher State bit in the loose synchronization LTV at the expiration of each timing anchor. FIG. 10 illustrates an example table 1000 showing example data fields contained in a loose synchronization LTV, according to various embodiments of the present disclosure. As shown in FIG. 10, the LTV spans one octet. Of course, this is merely one example configuration. Other configurations of data fields in the LTV are possible and within the scope of this disclosure.

Operation of the device transmitting discovery message:

The device transmitting a discovery message, such as a NAN USD Publisher device, may receive a command to start the discovery transmission procedure, e.g., USD Publish instance, at the requested time t_{pub_start}. The device may be required to start the discovery procedure at the commanded time to within a preconfigured accuracy range, e.g., with an accuracy of +/−5 ms. For example, the actual start time of the NAN Publish instance should be in the interval [t_{pub_start}−5 ms, t_{pub_start}+5 ms]. Similarly, the NAN Service Interface may further be used to configure dwell times in each SCP and NSCP for a USD Publish instance, and all dwell times (specifically SCP-to-NSCP and NSCP-SCP transition times) may also be required to be accurate to +/−5 ms of the requested dwell times.

Interworking between the trigger-sending device and the discovery messaging transmitting device:

The command to the discovery message transmitting device (e.g., a NAN USD Publisher) to start a discovery instance (e.g., a NAN USD Publish instance) may include one or more of a start time, a dwell time in various states, and state transition times. Based on the included information, the service layer issuing the command, or the discovery message transmitting device may provide to the trigger-sending device one or more of the expected start time and state transition times of the discovery instance. The state transition times may be provided to the trigger-sending device as timing anchors corresponding to the expected state-transition times, e.g., for updating the countdown timer in the loose synchronization information contained in the transmitted triggers.

Operation of the device scanning for a discovery message:

Based on the reception of loose synchronization information in a trigger, the service layer or the device scanning for discovery messages, such as a NAN module, may determine one or more of a current Predicted Publisher State and one or more state_transition_times. Using these, the NAN module may determine a duty cycle for scanning the default publish channel. In addition to adjusting the duty cycle, the NAN module may attempt to scan the default publish channel as soon as possible at the NSCP-to-SCP transition (see FIG. 5) as well as at the start of the subscribe instance if it starts in Predicted_Publisher_State=SCP.

Additionally, the service layer or the trigger-receiving device may provide to the discovery scanning device a new current Predicted_Publisher_State and one or more next state_transition_times for an already ongoing discovery scanning instance such as a NAN Subscribe instance. The scanning instance may modify its scan dwell times according to a new configuration.

It may happen that the time of the state transition indicated in the most recently received loose synchronization information has already elapsed and yet the discovery scanning device has not received further loose synchronization information. In such a case, the discovery scanning device may return to conventional operation after a configured delay (e.g., named syncExpiryTimer.) For example, the discovery scanning device may set a countdown timer initialized with a value syncExpiryTimer, and when the timer expires, the device resumes conventional operation instead of loose-synchronization-informed operation. Example values of syncExpiry Timer are 128 ms, 256 ms, and 512 ms. The timer may be set at the time of the state transition indicated in the loose synchronization information, e.g., the time corresponding to the countdown timer value in the loose synchronization information plus the time of reception of the loose synchronization information. Alternatively, the timer may be set at the time of reception of the loose synchronization information. In this latter case, the initialized value syncExpiry Timer may also depend on the loose synchronization information, e.g., the countdown timer value in the loose synchronization information.

Although FIGS. 3 through 10 illustrate example systems and techniques for trigger assisted synchronization for D2D discovery and related details, various changes may be made to FIGS. 3 through 10. For example, various components in FIGS. 3 through 10 could be combined, further subdivided, or omitted and additional components could be added according to particular needs. In addition, while shown as a series of steps, various operations in FIGS. 3 through 10 could overlap, occur in parallel, occur in a different order, or occur any number of times. In another example, steps may be omitted or replaced by other steps.

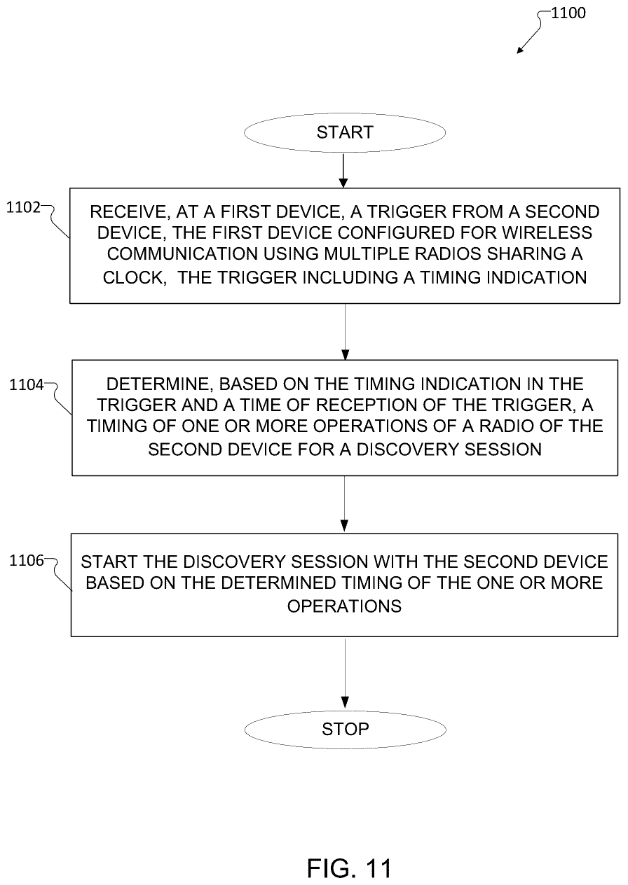

FIG. 11 illustrates a flow chart of a method 1100 for trigger assisted synchronization for D2D discovery at a receiver device according to various embodiments of the present disclosure. For ease of explanation, the method 1100 is described as being performed using the receiver device 302 and the timeline 400 shown in FIGS. 3 and 4. In some embodiments, the receiver device 302 can represent one or more components of the wireless network 100 (e.g., the STA 111). The embodiment of the method 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

As illustrated in FIG. 11, the method 1100 begins at step 1102. At step 1102, a first device receives, via a first radio, a trigger from a second device. The first device is configured for wireless communication using multiple radios sharing a clock. The multiple radios includes the first radio and a second radio, and the trigger includes a timing indication. In some embodiments, the timing indication includes (i) a first identifier of a current state of the second device and (ii) a countdown timer indicating a remaining duration of the current state. This could include, for example, the receiver device 302 receiving, via the BT radio 303, a BLE trigger 308 from the sender device 301, such as described in FIGS. 3 and 4.

At step 1104, the first device determines, based on the timing indication in the trigger and a time of reception of the trigger, a timing of one or more operations of a radio of the second device for a discovery session between the first device and the second device. This could include, for example, the receiver device 302 determining a timing of one or more operations of a WLAN radio 304 of the sender device 301, such as described in FIGS. 3 and 4.

At step 1106, the first device starts the discovery session with the second device based on the determined timing of the one or more operations. This could include, for example, the receiver device 302 starting the discovery session 309 with the sender device 301, such as described in FIGS. 3 and 4.

Although FIG. 11 illustrates one example of a method 1100 for trigger assisted synchronization for D2D discovery at a receiver device, various changes may be made to FIG. 11. For example, while shown as a series of steps, various steps in FIG. 11 could overlap, occur in parallel, occur in a different order, or occur any number of times.

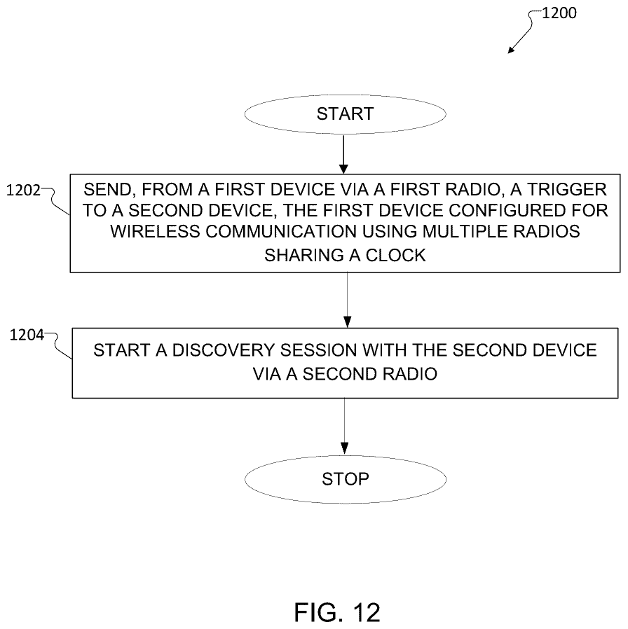

FIG. 12 illustrates a flow chart of a method 1200 for trigger assisted synchronization for D2D discovery at a sender device according to various embodiments of the present disclosure. For ease of explanation, the method 1200 is described as being performed using the sender device 301 and the timeline 400 shown in FIGS. 3 and 4. In some embodiments, the sender device 301 can represent one or more components of the wireless network 100 (e.g., the STA 111). The embodiment of the method 1200 shown in FIG. 12 is for illustration only. One or more of the components illustrated in FIG. 12 can be implemented in specialized circuitry configured to perform the noted functions or one or more of the components can be implemented by one or more processors executing instructions to perform the noted functions.

As illustrated in FIG. 12, the method 1200 begins at step 1202. At step 1202, a first device sends, via a first radio, a trigger to a second device. The first device is configured for wireless communication using multiple radios sharing a clock. The multiple radios include the first radio and a second radio. The trigger including a timing indication, where the timing indication is based on (i) a planned timing of one or more operations of the second radio for the discovery session, and (ii) a transmission time of the trigger via the first radio. This could include, for example, the sender device 301 sending, via the BT radio 303, a BLE trigger 308 to the receiver device 302, such as described in FIGS. 3 and 4.

At step 1204, the first device starts a discovery session with the second device via the second radio. In some embodiments, the discovery session is a USD Publish or Subscribe session. This could include, for example, the sender device 301 starting the discovery session 309 with the receiver device 302, such as described in FIGS. 3 and 4.

Although FIG. 12 illustrates one example of a method 1200 for trigger assisted synchronization for D2D discovery at a sender device, various changes may be made to FIG. 12. For example, while shown as a series of steps, various steps in FIG. 12 could overlap, occur in parallel, occur in a different order, or occur any number of times.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
receiving, at a first device via a first radio, a trigger from a second device, the first device configured for wireless communication using multiple radios sharing a clock, the multiple radios comprising the first radio and a second radio, the trigger including a timing indication;
determining, based on the timing indication in the trigger and a time of reception of the trigger, a timing of one or more operations of a radio of the second device for a discovery session between the first device and the second device; and
starting the discovery session with the second device based on the determined timing of the one or more operations.

2. The method of claim 1, wherein the timing of the one or more operations of the radio of the second device for the discovery session is determined based on (i) a reception time of the trigger via the first radio, and (ii) the timing indication included in the trigger.

3. The method of claim 1, wherein the timing indication included in the trigger comprises (i) a first identifier of a current state of the second device and (ii) a countdown timer indicating a remaining duration of the current state.

4. The method of claim 3, wherein the current state comprises an Unsynchronized Service Discovery (USD) Single Channel Publish (SCP) state or a USD non-SCP (NSCP) state.

5. The method of claim 1, wherein the discovery session comprises a Unsynchronized Service Discovery (USD) Publish or Subscribe session.

6. The method of claim 1, wherein:
the first radio comprises a Bluetooth radio; and
the second radio comprises a wireless fidelity (Wi-Fi) radio.

7. The method of claim 1, wherein:
the clock comprises an on-chip hardware clock; and
the first radio and the second radio also share a coexistence interface.

8. The method of claim 1, wherein the timing indication is based on (i) a planned timing of the one or more operations of the radio of the second device for the discovery session, and (ii) a transmission time of the trigger from the second device.

9. A device comprising:
multiple radios comprising a first radio and a second radio, the multiple radios sharing a clock; and
a processor operably connected to the multiple radios, the processor configured to:
receive, via the first radio, a trigger from a second device, the trigger including a timing indication;
determine, based on the timing indication in the trigger and a time of reception of the trigger, a timing of one or more operations of a radio of the second device for a discovery session between the device and the second device; and
start the discovery session with the second device based on the determined timing of the one or more operations.

10. The device of claim 9, wherein the processor is configured to determine the timing of the one or more operations of the radio of the second device for the discovery session based on (i) a reception time of the trigger via the first radio, and (ii) the timing indication included in the trigger.

11. The device of claim 9, wherein the timing indication included in the trigger comprises (i) a first identifier of a current state of the second device and (ii) a countdown timer indicating a remaining duration of the current state.

12. The device of claim 11, wherein the current state comprises an Unsynchronized Service Discovery (USD) Single Channel Publish (SCP) state or a USD non-SCP (NSCP) state.

13. The device of claim 9, wherein:
the first radio comprises a Bluetooth radio; and
the second radio comprises a wireless fidelity (Wi-Fi) radio.

14. A method comprising:
sending, from a first device via a first radio, a trigger to a second device, the first device configured for wireless communication using multiple radios sharing a clock, the multiple radios comprising the first radio and a second radio; and
starting a discovery session with the second device via the second radio,
wherein the trigger including a timing indication, the timing indication based on (i) a planned timing of one or more operations of the second radio for the discovery session, and (ii) a transmission time of the trigger via the first radio.

15. The method of claim 14, wherein the timing indication included in the trigger comprises (i) a first identifier of a current state of the first device and (ii) a countdown timer indicating a remaining duration of the current state.

16. The method of claim 15, wherein the current state comprises an Unsynchronized Service Discovery (USD) Single Channel Publish (SCP) state or a USD non-SCP (NSCP) state.

17. The method of claim 14, wherein the discovery session comprises a Unsynchronized Service Discovery (USD) Publish or Subscribe session.

18. The method of claim 14, wherein:
the first radio comprises a Bluetooth radio; and
the second radio comprises a wireless fidelity (Wi-Fi) radio.

19. The method of claim 14, wherein:
the clock comprises an on-chip hardware clock; and
the first radio and the second radio also share a coexistence interface.

20. The method of claim 14, wherein:
the trigger comprises a Bluetooth low energy (BLE) trigger; and
the discovery session comprises a device-to-device (D2D) discovery session.
